(19) United States
(12) Patent Application Publication
(10) Pub. No.: US 2014/0157890 A1
(43) Pub. Date: Jun. 12, 2014

(54) Method And Apparatus In A Medium Source Of A Fire-Fighting System

(71) Applicants: Jarkko Malinen, Lahti (FI); Klaus Gentz, Helsingfors (FI)

(72) Inventors: Jarkko Malinen, Lahti (FI); Klaus Gentz, Helsingfors (FI)

(73) Assignee: Marioff Corporation OY, Vantaa (FI)

(21) Appl. No.: 13/981,630

(22) PCT Filed: Jan. 25, 2012
(86) PCT No.: PCT/IB12/00107

§ 371 Date: Feb. 19, 2014

(30) Foreign Application Priority Data
Jan. 26, 2011 (FI) 20115079

(51) Int. Cl. A62C 37/50; G01F 23/14

(52) U.S. Cl. CPC A62C 37/50; G01F 23/14
USPC 73/299; 169/71

(57) ABSTRACT

Method for monitoring the amount of liquid of an extinguishing liquid container (1) of a fire-fighting apparatus. The extinguishing liquid container (1) is filled with extinguishing liquid such that a predefined volume (6) remains unfilled, the extinguishing liquid container is pressurized with a gas, e.g. using the filling connector (2), to the standby pressure (P2), which is higher than the switching point (Psw) of the pressure sensor or pressure switch (3), in which case when the amount of extinguishing liquid (5) in the extinguishing liquid container (1) decreases, the pressure (P2) of the extinguishing liquid container (1) decreases from the standby pressure (P2) as the proportion of the volume of the gas expands, in which case as a consequence of the decrease in the amount of extinguishing liquid and when the pressure decreases from the standby pressure to a second, lower value, which is set as the switching limit (Psw) of the pressure sensor or pressure switch (3), the pressure sensor or pressure switch (3) gives a signal, on the basis of which a notification is obtained about the low amount of liquid in the extinguishing medium container. The invention also relates to an apparatus.

### BACKGROUND OF THE INVENTION

The object of the invention is a method as defined in the preamble of claim 1.

Another object of the invention is an apparatus as defined in the preamble of claim 10.

The invention relates generally to a fire-extinguishing apparatus, in which a so-called hydraulic accumulator is used as an extinguishing medium source, which comprises at least one pressure container, in which hydraulic accumulator liquid extinguishing medium can be stored and which can be connected to a pressure source, more particularly to a pressurized gas container, i.e. a gas bottle. After the system has been activated by means of the pressure of the gas, liquid extinguishing medium or a mixture of liquid extinguishing medium and pressurized gas is conducted into a pipe leading to one or more spray heads. Some extinguishing systems, which comprise hydraulic pressure accumulators, are presented e.g. in publication U.S. Pat. No. 5,632,337.

The liquid of liquid containers can sometimes, e.g. as a result of leaks or, corresponding, decrease in the liquid container. For indicating the amount of liquid, various indicators of the surface height of the liquid are arranged in liquid containers. For example, for containers to be used in a vertical position, the rising pipe inside the liquid container and floats sliding along said pipe can be utilized for indicating the surface height of the amount of liquid. The float rises and falls along with the surface height of the liquid in the liquid container. The float is mechanically in connection with an indication device of surface height, which device shows the surface height on the scale of the indicator. This solution is viable and in use in _{/}accumulator units to be used in a vertical position, such as in Marioff Corporation Oy's HI-FOG® Machinery Accumulator Unit (MAU).

There are, however, cases in which the liquid container must be arranged in a position differing from the vertical position, e.g. owing to space restrictions or for other reasons. The solution described above is not suited e.g. to the indicating of the amount of liquid of, e.g. mainly cylindrical, liquid containers arranged in a horizontal position.

The aim of the present invention is to achieve an entirely new type of solution, by means of which the drawbacks of prior-art are avoided. Another aim of the invention is to achieve a solution for the measuring of the liquid surface in a container withstanding high pressure. Another aim of the invention is to achieve a solution for measuring the amount of liquid in pressure containers that are on a horizontal plane, in which containers methods based on floats cannot easily be utilized. One aim of the invention is to achieve a method, by means of which measuring of the amount of liquid of a hydraulic accumulator unit, said unit being on a horizontal plane, of a fire-fighting apparatus is possible. Another aim is to achieve a hydraulic accumulator unit, with its solution for measuring the surface height of a liquid, possessing good vibration tolerance and also a compact size. Another aim is to achieve a solution that is suited to the temperatures of the operating conditions of an accumulator unit, which temperatures can vary considerably, typically from +5° C. up to even +60° C. Also higher and lower temperatures than those presented above are possible. The pressure in a liquid container of an accumulator unit can rise to high values, e.g. to over 200 bar, so that one aim is to achieve a solution for the measuring of an amount of liquid, which solution is suited to high pressures. Another aim is to achieve a solution for the measuring of an amount of liquid, which does not have a negative impact on the mechanical strength of a liquid container of an accumulator unit, on official approvals, on serviceability, nor on corrosion resistance.

The method according to the invention is thus characterized by what is stated in claim 1.

The method according to the invention is also characterized by what is stated in claims 2-9.

The apparatus according to the invention is characterized by what is stated in claim 10.

The apparatus according to the invention is also characterized by what is stated in claims 11-18.

The solution according to the invention has a number of important advantages. By means of the invention it has been possible to achieve a solution for the measuring of the liquid surface in a container withstanding high pressure. In addition, by means of the invention a solution has been achieved for measuring the amount of liquid in pressure containers that are on a horizontal plane, in which containers methods based on floats cannot easily be utilized. With the method according to the invention, measuring of the amount of liquid of a hydraulic accumulator unit, said unit being on a horizontal plane, of a fire-fighting apparatus has been achieved. Additionally, a solution has been achieved for a hydraulic accumulator unit which, with its solution for measuring the amount of liquid, possesses good vibration tolerance and also a compact size. The solution according to the invention is suited to the temperatures of the operating conditions of an accumulator unit, which temperatures can vary considerably, typically from +5° C. up to even +60° C. The solution according to the invention is suited to high pressures and also to fairly low pressures. The solution according to the invention does not have a negative impact on the mechanical strength of a liquid container of an accumulator unit, on official approvals, on serviceability, nor on corrosion resistance.

### BRIEF DESCRIPTION OF THE FIGURES

In the following, the invention will be described in more detail by the aid of an example of its embodiment with reference to the attached drawing, wherein

FIG. 1 presents a simplified cross-section of a part of the device according to an embodiment of the invention,

FIG. 2 presents a detail A from FIG. 1,

FIG. 3 presents a container system according to an embodiment of the invention in a horizontal position, said system having two extinguishing liquid containers with one gas container,

FIG. 4 presents as a diagram a container system according to an embodiment of the invention, said system being simplified and in connection with a fire-extinguishing system, and

FIG. 5 presents a graph of the operation of the solution according to the invention.

### DETAILED DESCRIPTION OF THE INVENTION

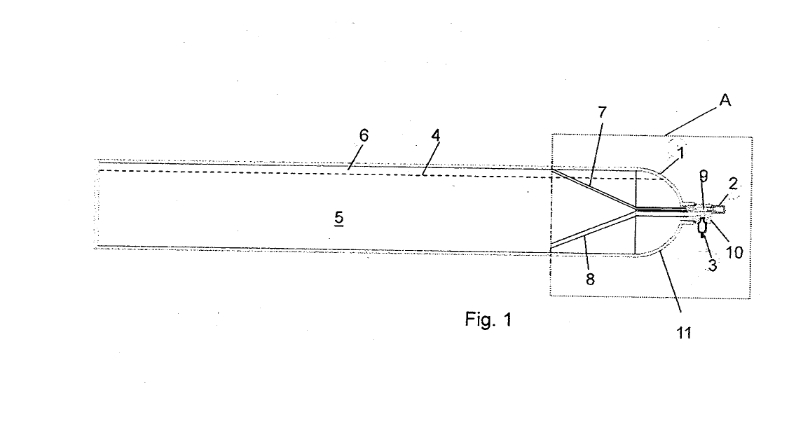

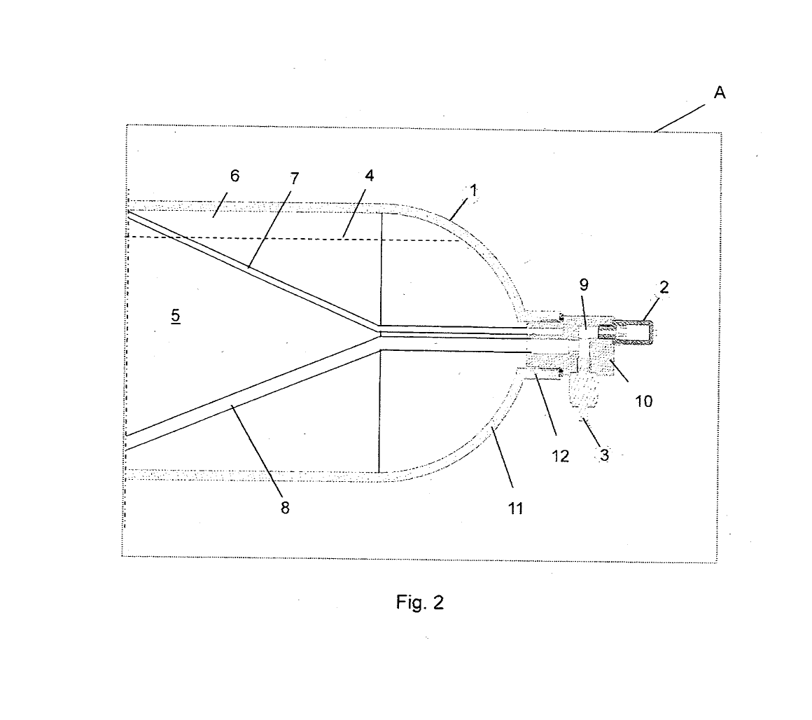

FIGS. 1 and 2 present an extinguishing liquid container 1 of an embodiment of the invention. The extinguishing liquid container is essentially cylindrical, with a mainly round cross-sectional shape. The extinguishing liquid container is arranged in FIG. 1 in an essentially horizontal position (in the horizontal direction), i.e. on its side. The extinguishing liquid container has been filled with a certain volume of extinguishing liquid 5, which has a surface height 4. A part of the volume of the extinguishing liquid container 1, the part marked with the reference number 6, does not contain extinguishing liquid but instead contains a gas. The gas can be air or some other suitable gas, such as nitrogen. In a preferred case, gas can be utilized in fire extinguishing together with extinguishing liquid.

The extinguishing liquid container 1 is e.g. a pressure container, in the domed end part 11 of which a plug part 10 is arranged. Typically an aperture with a neck 12 is arranged in the end part 11. Threads are arranged in the neck 12, into which threads the counterthreads of the plug part 10 fit. Medium channels 9, such as bores, are made in the plug part 10, for filling and emptying the container. The plug part can comprise channels for fixing various measuring sensors or other sensors and for creating a medium connection to the container space to be measured. A filling connector 2 and a pressure switch 3 are arranged in the plug part 10. A filling pipe 8 for liquid leads from the filling connector 2 to the container space. There is a connection from the container space of the extinguishing liquid container 1 to the pressure switch 3. The connection can be e.g. from the filling connector 2 or from the venting pipe 7 next to it.

When filling the extinguishing liquid container 1 with extinguishing liquid, the extinguishing liquid container is not completely filled full of liquid but instead a certain part-volume 6 is left in the container for a gas. For example, the venting pipe 7 leaves a small part-volume 6 in the extinguishing liquid container 1 for a gas. The part-volume 6, which contains gas, left in the extinguishing liquid container 1 produces a hydraulic capacitance. This overall flexibility of the system can be utilized in the measuring of the amount, i.e. the surface height, of the extinguishing liquid.

From the plug part 10 of the extinguishing liquid container there can be a medium connection onwards to a second extinguishing liquid container, e.g. via its plug part, in which case the extinguishing liquid containers connected together form a container system.

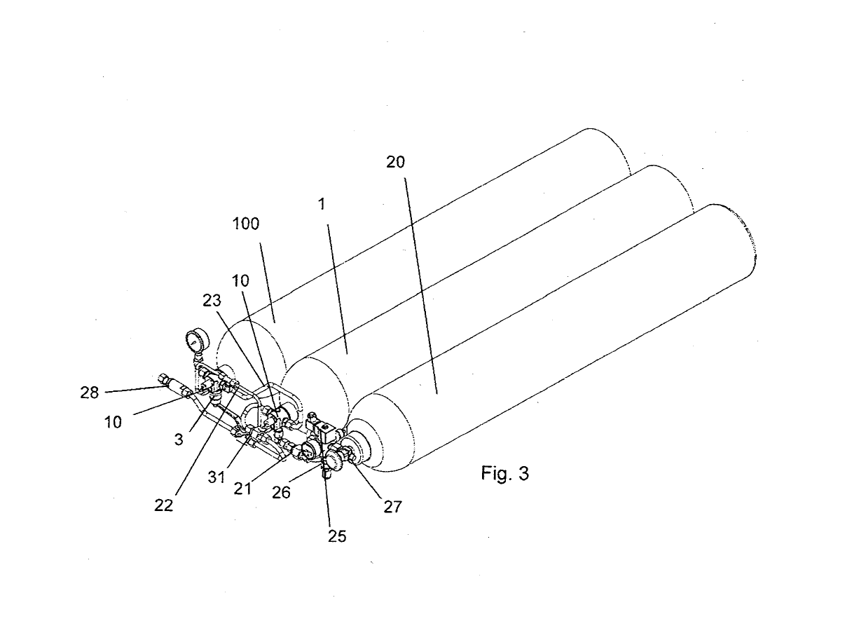

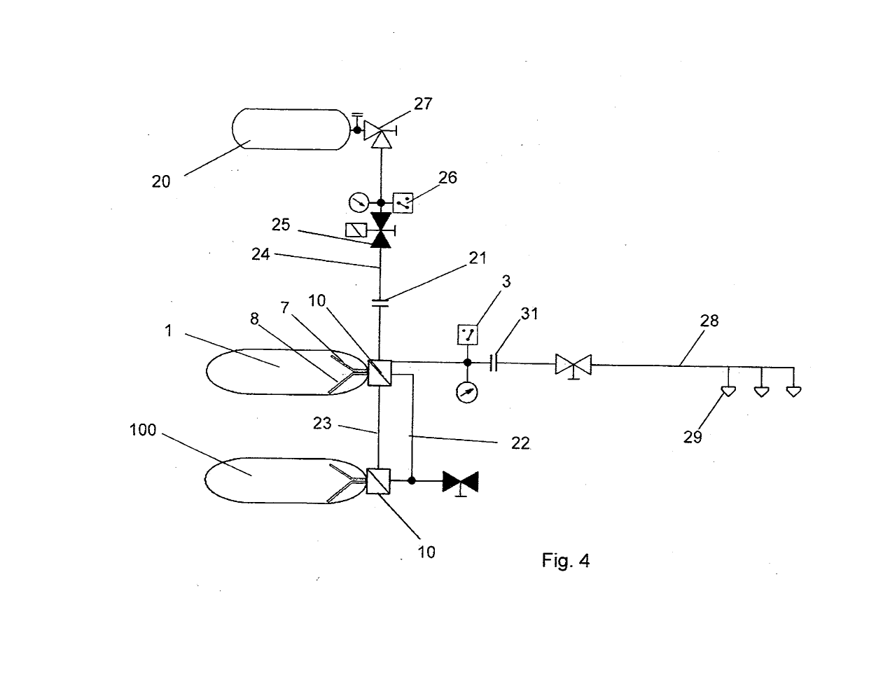

FIG. 3 presents one embodiment comprising two extinguishing liquid containers 1, 100, a first extinguishing liquid container 1, and a second extinguishing liquid container 100, as well as a gas source 20, such as a pressurized gas container i.e. a so-called gas bottle. At the same time reference is made to diagram 4, which presents a simplified fire-extinguishing apparatus, which comprises a solution according to the invention. The reference numbering of the components of FIG. 4 correspond to the extent applicable with the numbering of the components of FIG. 3. The extinguishing liquid containers 1, 100 are connected to each other with medium channels 22, 23, such as with pipe means or hose means. From the container space of the first extinguishing liquid container 1 is a first medium connection 23 via the plug part 10 to the plug part 10 of the second extinguishing liquid container 100 and onwards into its container space. In a corresponding manner a medium connection 24 is arranged from the gas source 20 to the plug part 10 of the first extinguishing liquid container 1. From the plug part 10 of the first extinguishing liquid container 1 is a second medium connection 22, a gas connection, to the plug part 10 of the second extinguishing liquid container 100. A first burst disk 21 is arranged in the medium connection 24 between the gas source 20 and the liquid container 1, which burst disk is configured to break and to open the connection from the gas source 20 to the extinguishing liquid container when the pressure in the medium connection 24 reaches a set value. Also arranged in connection with the gas source 20 are valve means 27, 25 and a pressure switch 26, which are configured to open when the fire-extinguishing system activates, e.g. under the control of a fire detector signal or manually or in some other manner.

From the extinguishing liquid container system comprising an extinguishing liquid container 1 or a number of extinguishing liquid containers 1, 100 is a medium connection 28 to at least one nozzle 29 intended to spray extinguishing medium when activated. The extinguishing liquid container system comprising an extinguishing liquid container 1 or a number of extinguishing liquid containers 1, 100 is, in the standby mode, separated from at least one medium pathway 28 leading to a nozzle 29 with a second burst disk 31.

In this case, in an HAU unit (Horizontal Accumulator Unit) arranged on a horizontal plane, the extinguishing liquid containers 1 are separated from the rest of the system with a burst disk 21, 31. In this case the pressure changes in the rest of the system do not, in the standby state, affect the extinguishing liquid containers 1, 100′, i.e. the water bottles. The pressure switch 3, which is typically set for rather a low pressure with regard to its switching point, is connected to the volume of the extinguishing liquid container system comprising an extinguishing liquid container 1 or a number of extinguishing liquid containers 1, 100.

The method according to the invention comprises, according to one embodiment, the following phases:
1. A container system comprising one or more extinguishing liquid containers 1, 100 is filled with liquid such that a predefined volume V2 in the container system remains unfilled. The volume V2 remaining unfilled can be determined e.g. with the length of the venting pipe in the container, which venting pipe has a certain volume. For example, an air volume of 2% can be set in an HAU unit with the length of the venting pipe 7.
2. The container system is pressurized with a gas to a pressure P2 higher than the switching point of the pressure switch 3 using the filling connector 2.
3. The system is now in a normal standby state.
4. When the amount of liquid decreases, e.g. owing to a leak, the pressure P2 of the container system decreases from the standby pressure when the gas expands. When the liquid has decreased sufficiently, the pressure switch gives a signal after it has reached its switching point Psw.

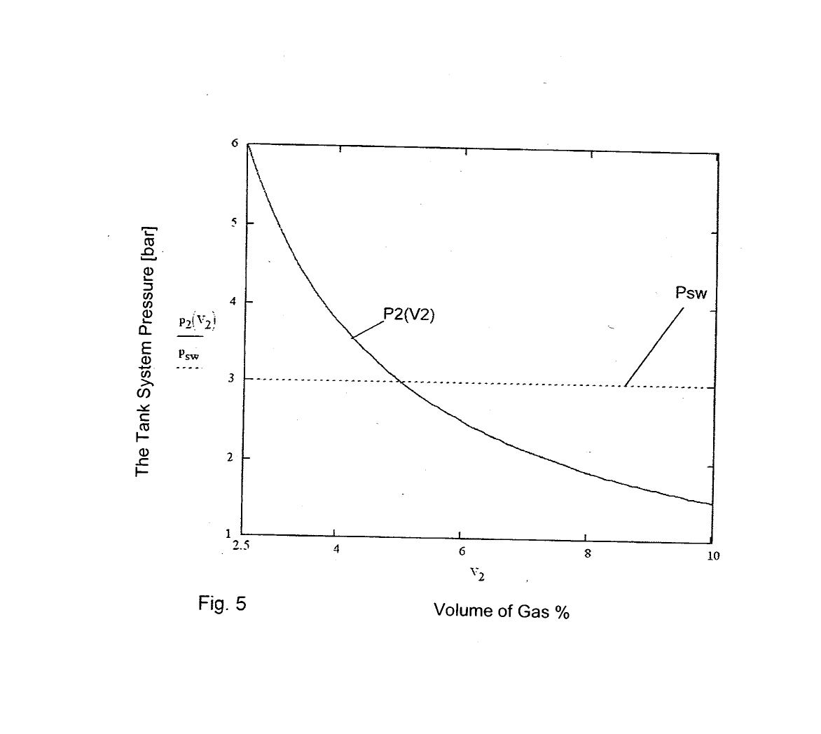

FIG. 5 presents as a diagram an example of the operation of an embodiment of a system according to the invention. In the figure, the pressure (extinguishing system in standby state) of the container system is presented on the vertical axis. The proportion (V2) of the volume of the gas as a percentage of the volume of the container or of the container system is given on the horizontal axis. In FIG. 1 this proportion of the volume is marked with the reference number 6. The curve P2(V2) describes the decrease of the pressure P2 of the container system and correspondingly the change in the proportion of the gas volume (V2) as a consequence of a decrease in the amount of liquid. In the standby state in the embodiment of the figure, the container/container system has been pressurized initially to the pressure P2, which is 6 bar. In this case the proportion V2 of the volume of the gas in the container/container system is 2.5% of the volume of the container or of the container system. When the liquid decreases in the container or container system, the pressure P2 decreases and the proportion V2 of the gas of the volume of the container increases in the manner shown by the curve P2(V2) of the figure. In this case a suitable alarm limit Psw (presented in FIG. 5 with a dashed line) can be set for the pressure switch 3, in which case after the pressure

P2 has reached the set limit Psw, the pressure switch gives a signal. In this case, when a container system comprising a container or a number of containers is in question, the proportion of the volume of the gas in the container/container system is known. In FIG. 5 the switching limit of the pressure switch is 3 bar, in which case the volume V2 of the gas in the liquid container is approx. 5%. The amount of liquid has therefore decreased from 97.5% of the volume to 95% of the volume. In the graph of the figure, it is assumed that the temperature is essentially constant. If a container or container system is in use in an embodiment in which the temperature varies, changes of temperature can be taken into account by applying the equation PV=nRT. In the embodiment of the invention it has been assumed that the liquid is essentially incompressible, such as water or an aqueous extinguishing medium.

Extinguishing liquid containers 1, 100 placed on a horizontal plane, such as in a HAU unit, are only one point of application of this surface indication method—the same technique is also applicable to other pressure containers separated from the rest of the system.

The invention thus relates to a method for monitoring the amount of liquid of an extinguishing liquid container 1 of a fire-fighting apparatus. The extinguishing liquid container 1 is filled with extinguishing liquid such that a predefined volume 6 remains unfilled, the extinguishing liquid container is pressurized with a gas, e.g. using the filling connector 2, to the standby pressure P2, which is higher than the switching point Psw of the pressure sensor or pressure switch 3, in which case when the amount of extinguishing liquid 5 in the extinguishing liquid container 1 decreases, the pressure P2 of the extinguishing liquid container 1 decreases from the standby pressure as the proportion of the volume of the gas expands, in which case as a consequence of the decrease in the amount of extinguishing liquid and when the pressure decreases from the standby pressure to a second, lower value, which is set as the switching limit Psw of the pressure sensor or pressure switch 3 the pressure sensor or pressure switch 3 gives a signal, on the basis of which a notification is obtained about the low amount of liquid in the extinguishing medium container.

According to one embodiment the extinguishing liquid container is formed into a container system comprising a number of extinguishing liquid containers 1, 100, which different extinguishing liquid containers 1, 100 are connected to, or can be connected to, each other with a medium pathway 22, 23, such as with pipe means or hose means.

According to one embodiment the extinguishing liquid container 1, 100 is a mainly cylindrical pressure container.

According to one embodiment a pressurized gas source 20 can be connected to the extinguishing liquid container 1, 100.

According to one embodiment the container system comprising an extinguishing liquid container 1 or a number of extinguishing liquid containers 1, 100 is at least in the non-active state of the fire-extinguishing system separated, with valve means or with burst disks 21, 31 breaking at a certain pressure, from the rest of the fire-extinguishing system.

According to one embodiment the extinguishing liquid container 1, 100 is arranged in a position differing from the vertical position, more particularly in a horizontal position.

According to one embodiment the extinguishing liquid container 1, 100 is arranged in a vertical position.

According to one embodiment the method is used in a fire-fighting system which is a fire-extinguishing system spraying, when activated, a liquid mist from at least one spraying nozzle 29.

According to one embodiment a liquid, or a mixture of a liquid and a gas, is used as an extinguishing medium.

The invention also relates to an apparatus for monitoring the amount of liquid of an extinguishing liquid container 1 of a fire-fighting apparatus. The extinguishing liquid container 1 comprises a filling connector 2 and a pressure sensor or pressure switch 3 in medium connection with the container space, which pressure sensor or pressure switch has a certain set switching pressure Psw, which extinguishing liquid container 1 is configured to be filled with extinguishing liquid such, that a predefined volume 6 remains unfilled, that the extinguishing liquid container is pressurized using with a gas to the standby pressure, which is higher than the set value Psw of the pressure sensor or pressure switch 3, in which case when the amount of extinguishing liquid 5 in the extinguishing liquid container 1 decreases, the pressure of the extinguishing liquid container 1 decreases from the standby pressure when the proportion of the volume of the gas expands, in which case as a consequence of the decrease in the amount of extinguishing liquid and when the pressure decreases from the standby pressure to a second, lower value, which is set as the switching limit Psw of the pressure sensor or pressure switch 3, the pressure sensor or pressure switch 3 gives a signal, on the basis of which a notification is obtained about the low amount of liquid in the extinguishing medium container.

According to one embodiment the extinguishing liquid container is formed into a container system comprising a number of extinguishing liquid containers 1, 100, which different extinguishing liquid containers 1, 100 are connected to, or can be connected to, each other with a medium pathway 22, 23, such as with pipe means or hose means.

According to one embodiment the extinguishing liquid container 1, 100 is a mainly cylindrical pressure container.

According to one embodiment a pressurized gas source 20 can be connected to the extinguishing liquid container 1, 100, which pressurized gas source is, when activated, configured to drive extinguishing liquid from the extinguishing liquid container into piping leading to a spray head, which extinguishing liquid container 1, 100 and pressurized gas source 20 together form the medium source of an extinguishing system.

According to one embodiment the container system comprising an extinguishing liquid container 1 or a number of extinguishing liquid containers 1, 100 is at least in the non-active state of the fire-extinguishing system separated, with valve means or with burst disks 21, 31 breaking at a certain pressure, from the rest of the fire-extinguishing system.

According to one embodiment the extinguishing liquid container 1, 100 is arranged in a position differing from the vertical position, more particularly in a horizontal position.

According to one embodiment the extinguishing liquid container 1, 100 is arranged in a vertical position.

According to one embodiment the apparatus is used in a fire-fighting system which is a fire-extinguishing system spraying, when activated, a liquid mist from at least one spraying nozzle 29.

According to one embodiment a liquid, or a mixture of a liquid and a gas, is used as the extinguishing medium of the fire-fighting system.

The method and apparatus according to the invention can be used very well in extinguishing systems in which water is used as an extinguishing medium. The method is particularly well suited for use as a medium source of extinguishing systems using liquid mist as an extinguishing medium. The method and apparatus according to the invention are particularly well suited to extinguishing medium containers which in the standby mode are separated from the rest of the system, e.g. with burst disks arranged in the medium pathways. The invention is suited to the measuring of the amount of liquid of elongated cylindrical pressure containers.

The invention can also be utilized in an extinguishing system intended for mobile means, such as for trains, train carriages, metro carriages or other suitable points. In this case to spray extinguishing medium it is possible to use e.g. spray heads that are able to form and to spray extinguishing medium mist over an extensive area at rather low extinguishing medium supply pressures and/or supply pressures of the medium pressure range and/or at high extinguishing medium supply pressures. One such spray head, which operates both at the supply pressures of the medium pressure ranges and at the supply pressures of a low pressure range, is presented in publication WO2006064082, the corresponding Finnish patent being FI116661B. With high supply pressures e.g. Marioff. Corporation Oy's spray heads that spray a mist over extensive areas can be utilized, such as e.g. the spray head presented in publication WO0145799. Also other appropriate spray heads can be used according to the requirements of each respective application point.

A liquid is used as the extinguishing medium, such as an aqueous extinguishing medium, such as water, and/or water to which is added an additive that enhances extinguishing, and/or a combination of a liquid and a gas. The extinguishing medium mist to be used is typically a liquid or a mixture of a liquid and a gas.

According to a typical embodiment a pressure, which is 2-300 bar, is used in the input of the extinguishing medium.

The invention is suited in connection with very many different types of extinguishing systems. It is extremely well suited for use in connection with fire-fighting systems spraying an extinguishing medium mist. The liquid mist produced with the nozzles can be extremely fine. The droplet size (Dv90) is typically less than 400 micrometers. Depending on the application target, the droplet size can also be larger.

It is obvious to the person skilled in the art that the invention is not limited to the embodiments presented above, but that it can be varied within the scope of the claims presented below. The characteristic features presented in the description mentioned in conjunction with each other can also be independent characteristic features.

1. Method for monitoring the amount of liquid of an extinguishing liquid container of a fire-fighting apparatus, characterized in that the extinguishing liquid container is filled with extinguishing liquid such that a predefined volume remains unfilled, the extinguishing liquid container is pressurized with a gas, e.g. using the filling connector, to the standby pressure (P2, which is higher than the switching point (Psw) of the pressure sensor or pressure switch, in which case when the amount of extinguishing liquid in the extinguishing liquid container decreases, the pressure (P2) of the extinguishing liquid container decreases from the standby pressure when the proportion of the volume of the gas expands, in which case as a consequence of the decrease in the amount of extinguishing liquid and when the pressure decreases from the standby pressure to a second, lower value, which is set as the switching limit (Psw) of the pressure sensor or pressure switch, the pressure sensor or pressure switch gives a signal, on the basis of which a notification is obtained about the low amount of liquid in the extinguishing medium container.

2. Method according to claim 1, characterized in that the extinguishing liquid container is formed into a container system comprising a number of extinguishing liquid containers, which different extinguishing liquid containers are connected to, or can be connected to, each other with a medium pathway, such as with pipe means or hose means.

3. Method according to claim 1, characterized in that the extinguishing liquid container is a mainly cylindrical pressure container.

4. Method according to claim 1, characterized in that a pressurized gas source can be connected to the extinguishing liquid container.

5. Method according to claim 1, characterized in that the container system comprising an extinguishing liquid container or a number of extinguishing liquid containers is at least in the non-active state of the fire-extinguishing system separated, with valve means or with burst disks breaking at a certain pressure, from the rest of the fire-extinguishing system.

6. Method according to claim 5, characterized in that the extinguishing liquid container is arranged in a position differing from the vertical position, more particularly in a horizontal position.

7. Method according to claim 1, characterized in that the extinguishing liquid container is arranged in a vertical position.

8. Method according to claim 1, characterized in that the method is used in a fire-fighting system which is a fire-extinguishing system spraying, when activated, a liquid mist from at least one spraying nozzle.

9. Method according to claim 1, characterized in that a liquid, or a mixture of a liquid and a gas, is used as an extinguishing medium.

10. Apparatus for monitoring the amount of liquid of an extinguishing liquid container of a fire-fighting apparatus, characterized in that the extinguishing liquid container comprises a filling connector and a pressure sensor or pressure switch in medium connection with the container space, which pressure sensor or pressure switch has a certain set switching pressure (Psw), which extinguishing liquid container is configured to be filled with extinguishing liquid such that a predefined volume remains unfilled, that the extinguishing liquid container is pressurized using with a gas to the standby pressure, which is higher than the set value (Psw) of the pressure sensor or pressure switch, in which case when the amount of extinguishing liquid in the extinguishing liquid container decreases, the pressure of the extinguishing liquid container decreases from the standby pressure when the proportion of the volume of the gas expands, in which case as a consequence of the decrease in the amount of extinguishing liquid and when the pressure decreases from the standby pressure to a second, lower value, which is set as the switching limit (Psw) of the pressure sensor or pressure switch, the pressure sensor or pressure switch gives a signal, on the basis of which a notification is obtained about the low amount of liquid in the extinguishing medium container.

11. Apparatus according to claim 10, characterized in that the extinguishing liquid container is formed into a container system comprising a number of extinguishing liquid containers, which different extinguishing liquid containers are connected to, or can be connected to, each other with a medium pathway, such as with pipe means or hose means.

12. Apparatus according to claim 10, characterized in that the extinguishing liquid container is a mainly cylindrical pressure container.

13. Apparatus according to claim 10, characterized in that a pressurized gas source can be connected to the extinguishing liquid container, which pressurized gas source is, when activated, configured to drive extinguishing liquid from the extinguishing liquid container into piping leading to a spray head, which extinguishing liquid container and pressurized gas source together form the medium source of an extinguishing system.

14. Apparatus according to claim 10, characterized in that the container system comprising an extinguishing liquid container or a number of extinguishing liquid containers is at least in the non-active state of the fire-extinguishing system separated, with valve means or with burst disks breaking at a certain pressure, from the rest of the fire-extinguishing system.

15. Apparatus according to claim 10, characterized in that the extinguishing liquid container is arranged in a position differing from the vertical position, more particularly in a horizontal position.

16. Apparatus according to claim 10, characterized in that the extinguishing liquid container is arranged in a vertical position.

17. Apparatus according to claim 10, characterized in that the apparatus is used in a fire-fighting system which is a fire-extinguishing system spraying, when activated, a liquid mist from at least one spraying nozzle.

18. Apparatus according to claim 17, characterized in that a liquid, or a mixture of a liquid and a gas, is used as the extinguishing medium of the fire-fighting system.
